(19) United States
(12) Patent Application Publication
(10) Pub. No.: US 2020/0278980 A1
(43) Pub. Date: Sep. 3, 2020

(54) DATABASE PROCESSING APPARATUS, GROUP MAP FILE GENERATING METHOD, AND RECORDING MEDIUM

(71) Applicant: SIMOUNT INC., Tokyo (JP)

(72) Inventor: Shigeki WATANABE, Tokyo (JP)

(21) Appl. No.: 16/650,856

(22) PCT Filed: Oct. 2, 2018
(86) PCT No.: PCT/JP2018/036920

§ 371 Date: Mar. 25, 2020

(30) Foreign Application Priority Data
Oct. 4, 2017 (JP) 2017-194559

(51) Int. Cl. G06F 16/25; G06F 16/11

(52) U.S. Cl. CPC G06F 16/254; G06F 16/116

(57) ABSTRACT

A database processing apparatus or the like is proposed, which is suitable for performing aggregation/search processing or the like for a database in the form of raw data such as CSV source data without involving preliminary extraction or the like. A database processing apparatus manages a group map file storing values converted from data values set as a name identification target when the database is subjected to aggregation, and an address map file for accessing each data item of a CSV file stored in a second storage unit. An aggregation result breakdown extraction unit uses the group map file to identify data of the CSV file that corresponds to the aggregation result, and uses the address map file to access the data of the CSV file so as to display the breakdown of the aggregation result on a display unit.

### TECHNICAL FIELD

The present invention relates to a database processing apparatus, a group map file generating method, and a recording medium, and more particularly, to a database processing apparatus or the like that performs processing for a database.

### BACKGROUND ART

The data warehouse concept, etc. has been proposed by William H. Inmon (Non-patent document 1). With conventional techniques, specifically, data loading is performed in a manner as described below, for example.

First, an ETL tool sequentially reads CSV source data from a CSV file, performs field selection, row selection, data cleaning, normalization, loader formatting, etc., and sequentially writes the CSV source partial data thus extracted to a file. Here, the file storing the CSV source data is designed as a file that differs from another file configured to manage the CSV source partial data.

Subsequently, an RDBMS loader generates specific RDBMS loader CSV data based on the CSV source data, and sequentially reads the specific RDBMS loader CSV data. Furthermore, the specific RDBMS loader CSV data thus read is subjected to field selection, data cleaning, normalization, data format conversion, key consistency checking, or the like, and the RDBMS table record data thus generated is sequentially written to a file.

### CITATION LIST

### Patent Literature

[Non-patent document 1]

William H. Inmon, “Corporate Information Factory—Construction and Management of Corporate Information Ecosystems”, Kaibundo Publishing Corporation, 1999.

### SUMMARY OF INVENTION

### Technical Problem

However, with such conventional techniques, only a part designed as required data is extracted from the CSV source data. That is to say, such an arrangement is not capable of performing processing such as searching or the like for other data that has not been extracted. Accordingly, with such an arrangement, in a case of performing processing such as searching or the like for such CSV source data that has not been extracted, such an arrangement requires review of the overall design, modification of a part of or all of the data loading process, and reloading and rebuilding the table structure or the like. Accordingly, it is difficult to modify the data loading process. That is to say, such an arrangement requires a perfect design of the data loading process in the first stage. Furthermore, the search results are not guaranteed to have a normalized data structure, and accordingly, the search results are not permitted to be specified as data for storage in a data warehouse.

Such processes are provided by means of a batch process. However, in a case in which the CSV source data has a very large amount of data, such as several dozen GB for example, such an arrangement requires a long period of time to access RDBMS table record data. Typically, such RDBMS table record data has an extremely large amount of data. Accordingly, in a case of employing a low-performance computer such as a general-purpose laptop personal computer, such a low-performance computer is not capable of performing such processing in a state in which such a large amount data is stored in its memory having only a memory capacity on the order of several GB. Accordingly, with such an arrangement, the CSV source data is stored in a hard disk or the like, and a part of the data is read to the memory as necessary so as to perform the processing. This requires a long period of time to perform processing such as searching.

Accordingly, it is a purpose of the present invention to provide a database processing apparatus or the like which is suitable for aggregation, searching, etc., for a database storing raw data such as the CSV source data or the like, without involving extraction or the like performed beforehand.

### Solution of Problem

A first aspect of the present invention relates to a database processing apparatus configured to perform processing of a database. The database processing apparatus includes a group map generating unit configured to generate a group map file that stores values converted from data values set as a name identification target in a manner such that they are associated with corresponding positions of the multiple data values set as the name identification target in the database when the database is subjected to aggregation processing.

A second aspect of the present invention relates to the database processing apparatus according to the first aspect. Each data item of the database is stored in a CSV file. The database processing apparatus includes an address map generating unit configured to generate an address map file for accessing each data item stored in the CSV file when or before the aggregation processing is performed.

A third aspect of the present invention relates to the database processing apparatus according to the second aspect. The database processing apparatus includes: an aggregation result breakdown extraction unit configured to extract a breakdown of the aggregation result obtained by the aggregation processing; a first storage unit; and a second storage unit. The first storage portion provides higher-speed accessing than the second storage unit. The second storage unit stores the CSV file. The address map file is used to access each data item of the CSV file stored in the second storage unit. The aggregation result breakdown extraction unit uses the group map file and the address map file read to the first storage unit that differs from the second storage unit to search the group map file for one or multiple data values, and to identify a position in the database for each of the one or the multiple data values. The aggregation result breakdown extraction unit uses the address map file to extract each data item that corresponds to the position from the CSV file.

A fourth aspect of the present invention relates to the database processing apparatus according to any one of the first aspect through the third aspect. The database processing apparatus further includes a storage unit configured to store a data structure for managing the database. The data structure includes a field definition storage portion that stores field definition information and a data storage portion that stores data. The data storage portion includes a database storage portion that stores data that defines the database and a map storage portion that stores the group map file. The database is provided with a virtual field definition based on the field definition information.

A fifth aspect of the present invention relates to a group map file generating method for generating a group map file using a database. The group map file generating method includes group map generating in which a group map generating unit included in a database processing apparatus generates a group map file that stores values converted from data values set as a name identification target in a manner such that they are associated with corresponding positions of the multiple data values set as the name identification target in the database when the database is subjected to aggregation processing.

A sixth aspect of the present invention relates to a computer readable recording medium configured to record a program for instructing a computer to function as a group map generating unit configured to generate a group map file that stores values converted from data values set as a name identification target in a manner such that they are associated with corresponding positions of the multiple data values set as the name identification target in the database when the database is subjected to aggregation processing.

It should be noted that the present invention may be regarded as a program according the sixth aspect.

Also, with the present invention, in the aggregation processing, data may be dynamically merged using a hash function without performing sorting. In the aggregation processing, typically, name identification requires performing sorting/merging processing after the data is read. With the present invention, by employing a hash function, such an arrangement allows the data to be dynamically merged without performing sorting, thereby providing further improved performance.

Also, the present invention may be regarded as a data structure described in the fourth aspect or a computer-readable recording medium that records the data structure. Also, with the data structure according to the fourth aspect, the data storage portion may include a table storage portion that stores a table for holding records that correspond to rows of the database. By adding and updating an actual field for the record, such an arrangement may be regarded as adding and updating the value of each actual field of the database. For example, by providing a table with the DB record ID=5 (which corresponds to the primary key in an RDBMS) that corresponds to the fifth row of the CSV file, this arrangement provides such a function. This allows the actual fields to be added and updated without changing the CSV file or the like for identifying each data item of the database.

### Advantageous Effects of Invention

With each aspect of the present invention, in the aggregation processing or the like performed for an original database, a group map file is generated, thereby allowing the aggregation results to be identified in a simple manner.

Furthermore, with the second aspect, this arrangement allows each data item of a CSV file that defines the database to be accessed using the address map file.

Moreover, the group map file and the address map file can each be configured as a fixed-length binary file. Accordingly, as described in the third aspect of the present invention, the group map file and the address map file each have a size that is dramatically smaller than that of the CSV file. This allows on-memory processing, thereby providing high-speed processing. In addition, by acquiring the aggregation result using the group map file and by accessing each data item stored in the database using the address map file, this arrangement allows the breakdown of the aggregation results (data stored in the database) to be acquired with high speed.

Moreover, as described in the fourth aspect of the present invention, this arrangement is capable of using a data structure that can be provided in a multi-value system or the like.

### BRIEF DESCRIPTION OF DRAWINGS

FIG. 1 shows a block diagram (a) showing an example configuration of a database processing apparatus 1 according to an embodiment of the present invention, and a block diagram (b) showing an example of a data structure of a CFILE 23 stored in a second storage unit.

FIG. 2 is a flowchart showing an example of the operation of the database processing apparatus 1 shown in FIG. 1.

FIG. 3 shows an example of a CSV file 43 and a group map file 49 generated based on the CSV file 43.

FIG. 4 shows an example of processing for generating the group map file using the CSV file and a master file.

FIG. 5 is a diagram showing an example of a data access operation of the database processing apparatus 1 shown in FIG. 1.

### DESCRIPTION OF EMBODIMENTS

Description will be made below with reference to the drawings regarding an example of the present invention. It should be noted that the present invention is not restricted to the example.

### EXAMPLE

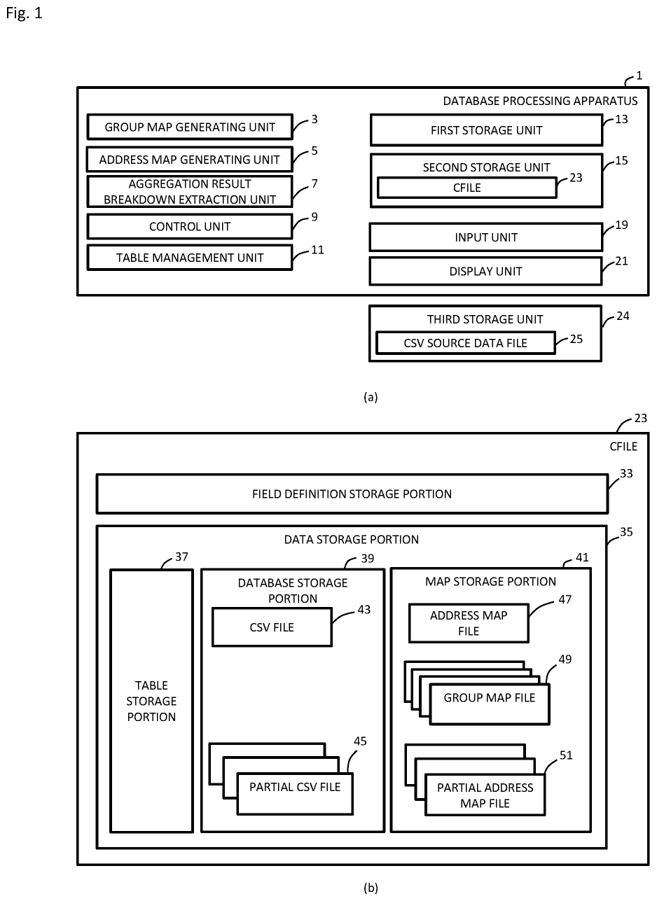

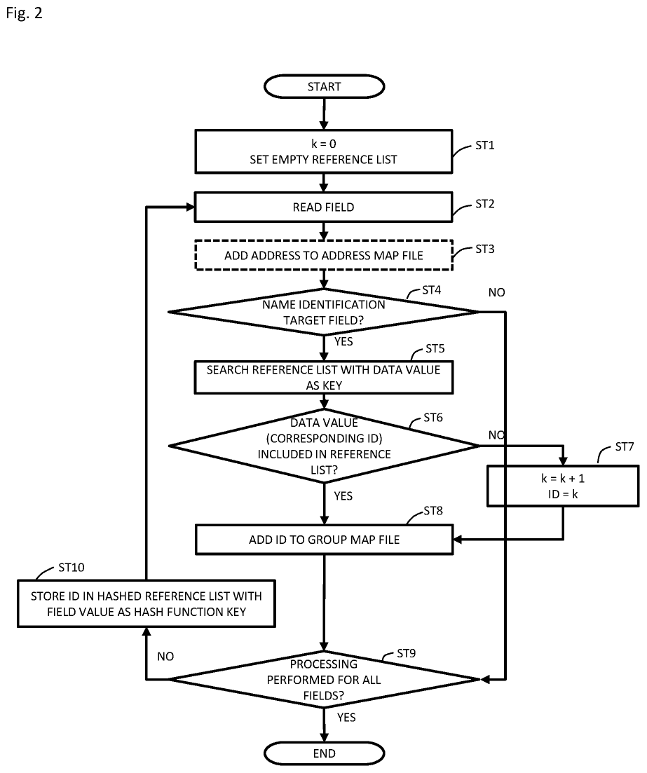

FIG. 1 shows a block diagram (a) showing an example configuration of a database processing apparatus 1 according to an embodiment of the present invention. FIG. 1 shows a block diagram (b) showing an example of a data structure of a CFILE 23 stored in a second storage unit 15. FIG. 2 is a flowchart showing an example of the operation of the database processing apparatus 1 shown in FIG. 1.

Referring to FIG. 1 (a), the database processing apparatus 1 includes a group map generating unit 3 (an example of a “group map generating unit” in the present claims), an address map generating unit 5 (an example of an “address map generating unit” in the present claims), an aggregation result breakdown extraction unit 7 (an example of an “aggregation result breakdown extraction unit” in the present claims), a control unit 9, a table management unit 11, a first storage unit 13 (an example of a “first storage unit” in the present claims), a second storage unit 15 (an example of a “second storage unit” in the present claims), an input unit 19, and a display unit 21.

A third storage unit 24 stores a CSV source data file 25. The CSV source data file 25 stored in the third storage unit 24 is configured as a CSV file that manages raw data. For simplification of description, description will be made regarding an example in which there is a single CSV source data file 25. In a case in which there are multiple CSV source data files 25, such an arrangement can be made in the same manner.

With conventional techniques, only a required part is extracted from the CSV source data file so as to generate RDBMS table record data. The RDBMS table record data according to such a conventional technique has an amount of data that is drastically larger than that of the CSV source data file. Furthermore, with such an arrangement, when a new part is required, a redesign is required.

The first storage unit 13 is configured to support high-speed data access as compared with the second storage unit 15. For example, the first storage unit 13 is configured as memory. In contrast, the second storage unit 15 is configured as a hard disk or the like. With a typical laptop PC, the second storage unit 15 is capable of storing several hundred GB of information. In contrast, the first storage unit 13 is capable of storing several GB of information. Such an arrangement is capable of providing higher-speed accessing of the information stored in the first storage unit 13 as compared with the information stored in the second storage unit 15.

A given table in a multi-value system is composed of two kinds of directories on an OS (a DICT portion that stores a field definition and a DATA portion that stores data). Typically, each DICT portion is assigned to a single DATA portion in a one-to-one manner. Also, each DICT portion may be assigned to multiple DATA portion directories.

The second storage unit 15 stores the CFILE 23. Referring to FIG. 1 (b), the CFILE 23 includes a field definition storage portion 33 (which corresponds to the DICT portion employed in a multi-value system) that stores field definition information and a data storage portion 35 (which corresponds to the DATA portion employed in the multi-value system) that stores data. The data storage portion 35 includes a table storage portion 37, a database storage portion 39, and a map storage portion 41. The field definition storage portion 33, the data storage portion 35, the table storage portion 37, the database storage portion 39, and the map storage portion 41 are each configured as a directory (folder). This data structure is recorded in a management table VOC. Here, the management table VOC corresponds to a system table (which will also be referred to as an “MD”) employed in a multi-value system so as to manage the data structure information with respect to all the tables. The management table VOC is composed of a field definition storage portion and a data storage portion in the same manner as the CFILE. The data storage portion stores the data structure information with respect to all the tables. It should be noted that the CFILE is provided with an additional data storage portion as necessary. That is to say, a single CFILE may include multiple data storage portions.

The database storage portion 39 stores a CSV file 43 and partial CSV files 45.

When the user operates the input unit 19 so as to generate the CFILE 23, the CSV source data file 25 is copied or moved as the CSV file 43. It should be noted that various kinds of processing may be performed in this operation, examples of which include row skipping, code conversion into FTF8, half-width/full-width character conversion, generation of a composite key CSV, etc. The CSV file 43 is completely (or substantially) the same as the CSV source data file 25. That is to say, even if there is data that was not required in the first stage but is required in a subsequent stage, the CFILE 23 also includes such data. Accordingly, even in this case, with such an arrangement, redesign is not required.

The partial CSV file 45 is obtained by extracting only specific fields in order to provide high-speed search of the specific fields in a case in which each row of the CSV file 43 has a large number of fields, for example (such multiple specific fields can be coupled; that is to say, each row of the partial CSV file 43 can be composed of multiple kinds of fields specified as desired). This arrangement provides an effect that is similar to a column DBMS in an RDBMS. When the user operates the input unit 19 so as to execute a map generation command, this arrangement is capable of generating one or multiple partial CSV files as a subsequent operation. For example, in a case in which the file name of the CSV file 43 is “C”, the file name of the partial CSV file 45 composed of the 17-th field and the fifth field of the CSV file 43 is set to “C17_5”.

The map storage unit 41 stores an address map file 47, group map files 49, and partial address map files 51.

The address map file 47 manages the addresses for accessing the CSV files 43 stored in the second storage unit 15. The address map file 47 is configured as a fixed-length binary file that corresponds to the CSV file 43. For example, the address map file 47 stores the total number of items, the second row start address, the third row start address, . . . , the last row start address, and (the last row end address+1). It should be noted that the address map file 47 may be generated when the CFILE 23 is generated. Also, instead of generating the address map file 47 when the CFILE 23 is generated, the address map file 47 may be generated when the data aggregation/search processing is performed. Even in a case in which the address map file 47 is generated as a subsequent operation, there is no measurable difference due to the additional period of time required to generate the address map file 47 as compared with the search time including no period of time for generating the address map file 47.

When the user operates the input unit 19 so as to execute a data aggregation/search command for the CSV file 43, the group map file 49 is registered as necessary. The group map file 49 has a data structure configured as a binary fixed-length file in which the “names” identified in name identification executed in the data aggregation processing for all the rows are replaced by integers starting from “1” that represent the order of detection in the data search.

Regarding the comparison of the data amount, the size of each of the group map files 49 is smaller than that of the address map file 47. For example, in a case in which the CSV file 45 stores 20,000,000 items of data (approximately 33 GB), the address map file 47 has a size of 96.5 MB, and each group map file 49 has a size that is equal to or smaller than 58 MB. This allows high-speed data access in an always on-memory state (i.e., this allows high-speed data accessing and processing in a state in which such a file is stored in the first storage unit 13). This provides dramatically high-speed processing even in a case of employing a low-performance PC).

Each partial address map file 51 is associated with the corresponding partial CSV file 45. Specifically, the partial address map file 51 manages the address for accessing the partial CSV file 45 stored in the second storage unit 15. The relation between the partial CSV file 45 and the partial address map file 51 is the same as that between the CSV file 43 and the address map file 47. When a field is detected in the partial CSV file 45 as a search result (to be displayed), the partial address map file 51 that corresponds to the partial CSV file 45 is configured to allow the data to be extracted with high speed (even in a case in which such a partial address map file 51 cannot be used, such data can be extracted from the original CSV file 43 using the original address map file 47). It should be noted that, if a group map file is generated corresponding to the partial CSV file 45, such a group map file has a size that is similar to that of the group map file 49 for the CSV file 43. Accordingly, instead of generating such a group map file, the group map file 49 for the original CSV file 43 may be employed.

The table storage portion 37 holds records that correspond to the rows of the CSV file 43 (empty records each having only an [symbol] ID that corresponds to the primary key in an RDBMS), the number of which corresponds to that of the rows of the CSV file 43. The table management unit 11 performs processing for the table storage portion 37. For example, in a case in which the CSV file 43 is composed of seven rows, the table management unit 11 generates and stores seven records with [symbol] IDs of 1 to 7. Each empty record can be updated such that it has a desired number of actual fields. Accordingly, this arrangement allows the CSV file 43 to be virtually (but practically) updated without changing the CSV file 43. Specifically, the database storage portion 39 and the map storage portion 41 are both generated such that they are associated with the data and the row numbers of the CSV file 43. The table storage portion 37 holds records each having an ID that corresponds to a row number of the CSV file 43. That is to say, the table storage portion 37 is associated with only the row numbers of the CSV file 43. An operation in which a record is added or updated is supported as an operation in which a new field is added or updated with respect to the records stored in the table storage portion 37 that correspond to the rows in the CSV file 43 (basically, no “row” is added) Accordingly, such an operation is performed in only the table storage portion 37. That is to say, this has no effect on the database storage portion 39 and the map storage portion 41. The group map file 49 is held as a search result in a search. Accordingly, the search result is not updated. A new search is supported using a new group map file. Accordingly, such an arrangement has the potential to “add” such a new group map. However, the group map file thus added is by no means changed.

The field definition storage portion 33 stores field definition information. The field definition information allows virtual field definition in the database. For example, the CSV file 43 and the table storage portion 37 each store a table that defines actual field values. In addition, this arrangement allows various kinds of virtual field values to be obtained by calculating various kinds of values such as aggregation values according to the virtual field definition.

Description will be made with reference to FIG. 2 regarding an example of an operation of the database processing apparatus 1 shown in FIG. 1 for performing data aggregation/search processing for the CSV file 43 so as to generate the address map file 47 and the group map file 49. It should be noted that, in a case in which the address map file 47 had been already generated when the CFILE was generated or otherwise in previous data/aggregation processing, there is no need to generate the address map file 47. That is to say, only the group map file 49 may preferably be generated.

As preliminary processing, the control unit 9 sets a variable k to 0, and sets an empty reference list on the memory (Step ST1).

The control unit 9 reads a field from the CSV file 43 (Step ST2). Only when an address map file 47 uniquely corresponding to the CSV file 43 has not yet been generated, the control unit 9 generates an empty address map file 47, and performs address writing processing as described below. That is to say, when a given field is an n-th (n represents an integer of 2 or more) row start field, the address map generating unit 5 adds the n-th row start address to the address map file 47. When a given field is a last row end field, the address map generating unit 5 stores (last row end address+1) (Step ST3). It should be noted that, in a case in which there is a completed address map file 47 from the start of the operation, only the field reading operation (Step ST2) is performed. That is to say, Step ST3 is not executed.

The group map generating unit 3 judges whether or not the field thus read matches the name identification target field (Step ST4). When judgment has been made that the field thus read matches the name identification target field, the flow proceeds to Step ST5. Otherwise, the flow proceeds to Step ST9.

In Steps ST5 and ST6, judgment is made regarding whether or not a given field value is a new value. When judgment has been made that the given field value is a new value, k is incremented by 1, and the ID assigned to the new value is set to k (Step ST7). Subsequently, the ID is added to the group map file 49 (when there is no group map file 47, a new group map file 49 is generated) (Step ST8), and the flow proceeds to Step ST9. When judgment has been made that the given field value is not a new value, the corresponding ID is added to the group map file 49.

In Step ST9, the control unit 9 judges whether or not the processing has been performed for all the fields. When there is a field that has not been subjected to the processing, the ID is written to a hashed reference list (Step ST10). Subsequently, the flow returns to Step ST2, and the processing is performed for the remaining fields that have not been subjected to the processing. When judgment has been made that the processing has been performed for all the fields, the control unit 9, only when the table storage portion 37 is empty, adds empty records (dummy records) with the row numbers as the IDs, the number of which matches that of the rows.

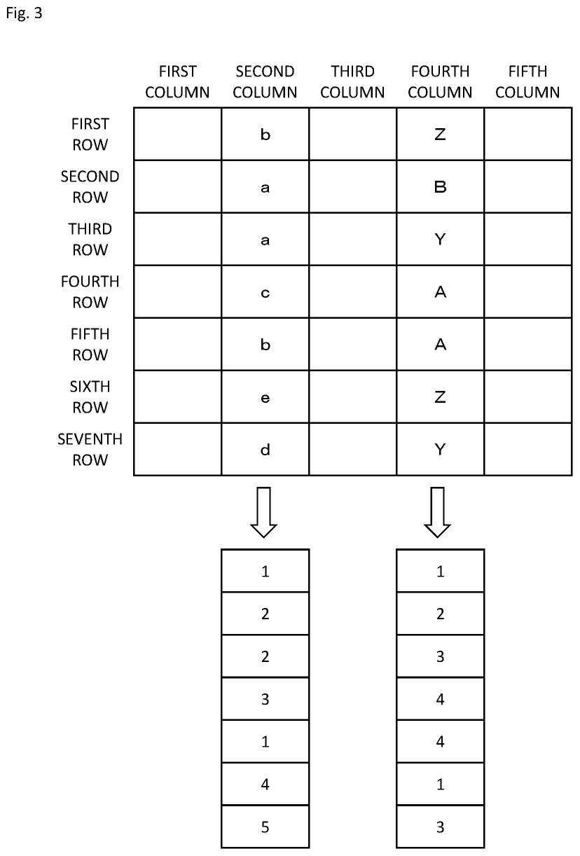

FIG. 3 is a diagram showing an example of the CSV file 43 and the group map file 49 generated based on the CSV file 43. When the second-column fields of the CSV file 43 are selected as the name identification, the second-column fields of the CSV file 43, i.e., “b”, “a”, “a”, “c”, “b”, “e”, and “d”, are selected. The corresponding group map file 49 is generated so as to have IDs each configured as a number in the order of detection, i.e., to have the IDs “1”, “2”, “2”, “3”, “1”, “4”, and “5”. When the fourth-column fields of the CSV file 43 are selected as the name identification, the fourth-column fields of the CSV file 43, i.e., “Z”, “B”, “Y”, “A”, “A”, “Z”, and “Y”, are selected. The corresponding group map file 49 is generated so as to have the IDs “1”, “2”, “3”, “4”, “4”, “1”, and “3”. That is to say, when different aggregation is performed, a different group map file 49 is generated.

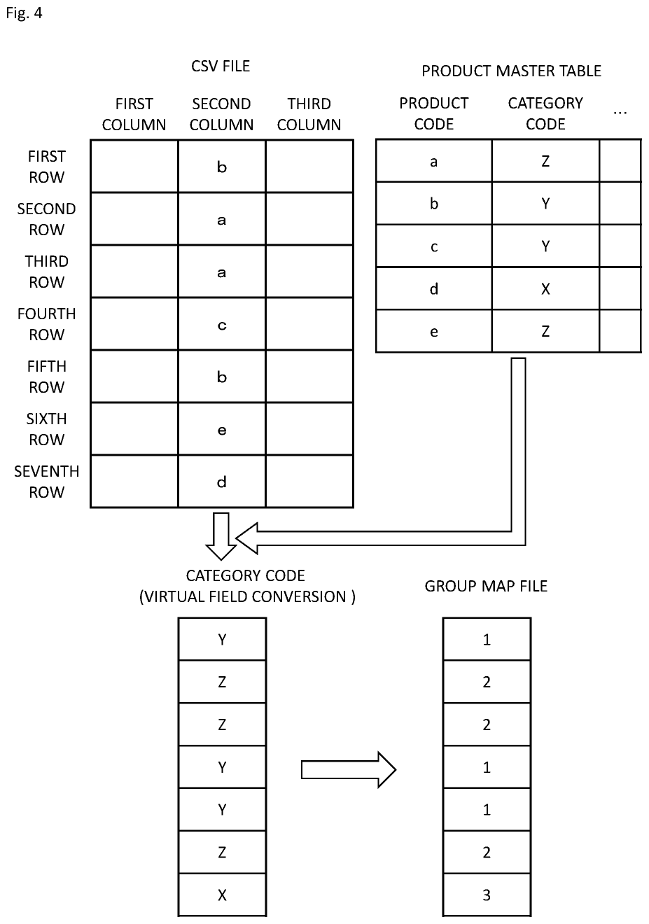

The group map file 49 can be generated using a composite value of multiple fields or using a value obtained by means of “JOIN” or the like executed based on a master table using the field values as keys, in addition to being generated based on a single-field value. Description will be made with reference to FIG. 4 regarding an example of the generation of the group map file using the master table. The CSV file to be searched is transaction data in the distribution industry, and records which products are sold and the amount of sales for each product. In the data search, aggregation is performed for each category, and the corresponding group map is generated. However, the CSV file 43 includes no category code as its data, and includes only product codes. The master table is configured as a table employed in a multi-value system, and has the same basic function as that provided by a table having a normalized record structure employed in an RDBMS. On the system, the product master table is stored such that each product code is associated with the corresponding category code. In the example shown in FIG. 4, the second-column fields of the CSV file, i.e., “b”, “a”, “a”, “c”, “b”, “e”, and “d”, each represents a product code. In the product master table, the product codes “a”, “b”, “c”, “d”, and “e” are associated with the category codes “Z”, “Y”, “Y”, “X”, and “Z”. In the data search, “JOIN” processing is performed using the product code as a key based on the product master table, so as to dynamically generate the category codes in the data search. That is to say, name identification aggregation is performed as if the CSV file included the category codes. This arrangement allows the group map file to be generated based on the category codes that are not included in the CSV file. The “JOIN” supported by this arrangement is a mechanism that differs from “JOIN” supported by SQL or the like (which is scripted and executed in each step as a procedure for generating a relation between fields and keys in SQL). For example, by defining a “category code” as a virtual field in the field definition storage portion 33, this arrangement is capable of handling the category code as an entity code, thereby providing a simple and general-purpose operation.

The aggregation result breakdown extraction unit 7 reads the group map file 49 and the address map file 47 included in the CFILE 23 from the second storage unit 15, and instructs the first storage unit 13 to store the group map file 49 and the address map file 47 thus read. The group map file 49 and the address map file 47 thus stored in the first storage unit 13 are used to read the breakdown of the aggregation result (data of the CSV file 43, i.e., RAW data) with high speed, and the breakdown of the aggregation result thus read is displayed on the display unit 21. For example, in the example shown in FIG. 3, when the user operates the input unit 19 so as to issue an instruction to display the breakdown of the aggregation result with respect to “a” and “e” in the second column, the group map file 49 is searched for “2” and “4” so as to acquire the corresponding row numbers in the CSV file 43 (“2”, “3”, and “6” in the example shown in FIG. 3). The row numbers thus acquired are used with reference to the address map file 47 so as to directly access the records of the RAW data managed by the CSV file 43, and the acquired data is displayed on the display unit 21.

For example, in a case in which the CSV file 43 stores 20,000,000 items of data having a data amount of approximately 33 GB, when search conditions are set for three kinds of fields, and data sorting is set for the three kinds of fields, with the present embodiment, this arrangement requires an average processing time of three minutes to complete the search from the preparation of the CSV source file even in a case of employing a low-performance laptop PC. With the background techniques, such an arrangement requires a cost or the like for generating the record data in the form of a DBMS table. Furthermore, such an arrangement exhibits only poor search performance as compared with the present invention. Specifically, such an arrangement requires a search time on the order of days or weeks. The difference in search performance is due to the following fact. That is to say, in a case in which an RDBMS table is searched, entity records or entity indexes (having a B-TREE as a physical structure in this example) are read. As the internal processing, there is a need to read data with reference to pointers in units of records. An index may be generated for the data. However, such data is written on a medium (hard disk) in a physically dispersed manner. In particular, in a case of handling a large amount of data, the data is written such that it is greatly dispersed. Accordingly, when a large amount of data is handled, it becomes harder to make use of the cache effect on the disk side in the reading operation. Specifically, the overall reading speed becomes 100 times or more lower than that when a typical cache effect is provided. With the present invention, in the data search for acquiring aggregation results or the like, the CSV file 43 itself, which is configured as a single file storing data such that it is not greatly dispersed in a physical manner, is sequentially read from the beginning, thereby raising the cache efficiency up to its maximum level. This provides high-speed performance even in a case of employing a medium that exhibits only low data-access performance such as a 2.5-inch hard disk that is a standard built-in component of a laptop PC (which provides poor data access performance as compared with a 3.5-inch hard disk mounted on a typical server). In addition, typically, there is a need to perform sort/merge processing in order to support the name identification after the data reading. With the present experiment, in the data aggregation, the data thus read is dynamically merged using a hash function instead of performing sorting (see Step ST5 in FIG. 2).

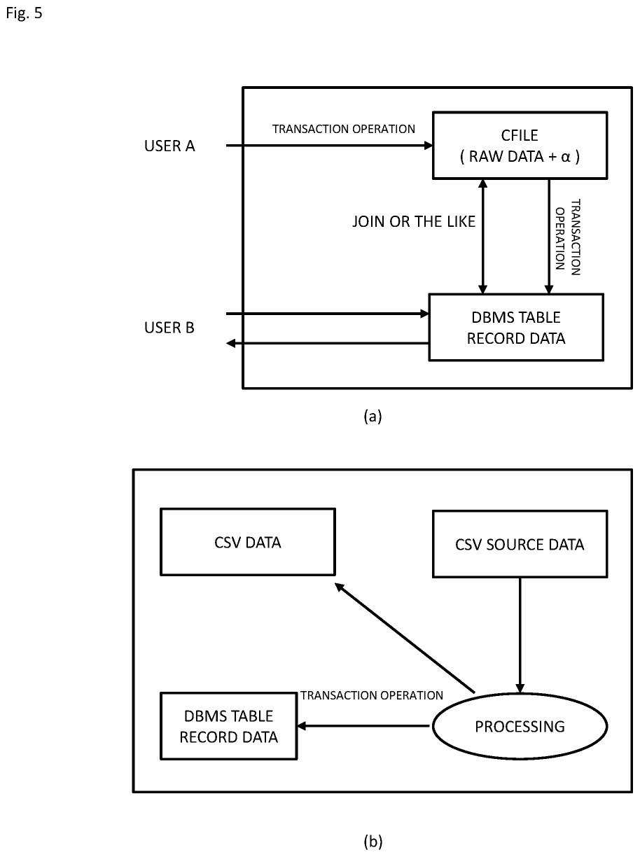

FIG. 5 is a diagram showing an example of a data access operation of the database processing apparatus 1 shown in FIG. 1.

Referring to FIG. 5 (a), this arrangement allows the user A to perform various kinds of processing using the search function by directly reading from and writing to the CFILE. For example, this arrangement allows the user to perform processing using a function group supported by a programming language, e.g., typical third-generation programming language (3GL) such as JAVA (trademark), C++, or .NET, a fourth-generation programming language (4GL) such as the search language IQL, IQLL that supports OLAP, or the like. Also, by using the CFILE, this arrangement allows actual fields to be associated with and added to a desired row or the like using the dummy records supported by the table storage unit 37. Also, this arrangement allows the field definition storage table 33 to support virtual field definition.

By performing JOIN, DRILL THROUGH, or the like on the CFILE, this arrangement provides DBMS table record data. Furthermore, after the CFILE is subjected to name identification, statistical aggregation, field selection, data cleaning, normalization/multi-valued processing, data format definition, dynamic key consistency checking, or the like, this arrangement is capable of providing DBMS table record data using the direct write function. The DBMS table record data thus generated can be handled in the same manner as the aggregation data. That is to say, a user B is able to perform various kinds of processing using the DBMS table record data.

Description will be made with reference to FIG. 5 (b) regarding the fact that the database processing apparatus 1 supports data loading with a high degree of freedom. By subjecting the CSV source data to name identification or the like, this arrangement is capable of providing the DBMS table record data using the direct write function. For example, this arrangement requires only a minimum of 7 minutes to 20 minutes to complete the aggregation processing on a laptop PC for three kinds of items based on data having approximately 20,000,000 rows (approximately 33 GB) (as result data rows, thousands to millions of rows). Furthermore, this arrangement is capable of writing the result data in the form of CSV data.

### REFERENCE SIGNS LIST

1 database processing apparatus, 3 group map generating unit, 5 address map generating unit, 7 aggregation result breakdown extraction unit, 9 control unit, 11 table management unit, 13 first storage unit, 15 second storage unit, 19 input unit, 21 display unit, 23 CFILE, 24 third storage unit, 25 CSV source data file, 33 field definition storage portion, 35 data storage portion, 37 table storage portion, 39 database storage portion, 41 map storage portion, 43 CSV file, 45 partial CSV file, 47 address map file, 49 group map file, 51 partial address map file.

1. A database processing apparatus configured to perform processing of a database, comprising a group map generating unit configured to generate a group map file that stores values converted from data values set as a name identification target in a manner such that they are associated with corresponding positions of the plurality of data values set as the name identification target in the database when the database is subjected to aggregation processing.

2. The database processing apparatus according to claim 1, wherein each data item of the database is stored in a CSV file,
and wherein the database processing apparatus comprises an address map generating unit configured to generate an address map file for accessing each data item stored in the CSV file when or before the aggregation processing is performed.

3. The database processing apparatus according to claim 2, comprising:
an aggregation result breakdown extraction unit configured to extract a breakdown of the aggregation result obtained by the aggregation processing;
a first storage unit; and
a second storage unit,
wherein the first storage portion provides higher-speed accessing than the second storage unit,
wherein the second storage unit stores the CSV file,
wherein the address map file is used to access each data item of the CSV file stored in the second storage unit,
wherein the aggregation result breakdown extraction unit uses the group map file and the address map file read to the first storage unit that differs from the second storage unit to search the group map file for one or a plurality of data values, and to identify a position in the database for each of the one or the plurality of data values,
and wherein the aggregation result breakdown extraction unit uses the address map file to extract each data item that corresponds to the position from the CSV file.

4. The database processing apparatus according to claim 1, further comprising a storage unit configured to store a data structure for managing the database,
wherein the data structure comprises a field definition storage portion that stores field definition information and a data storage portion that stores data,
wherein the data storage portion comprises a database storage portion that stores data that defines the database and a map storage portion that stores the group map file,
and wherein the database is provided with a virtual field definition based on the field definition information.

5. A group map file generating method for generating a group map file using a database, wherein the group map file generating method comprises group map generating in which a group map generating unit included in a database processing apparatus generates a group map file that stores values converted from data values set as a name identification target in a manner such that they are associated with corresponding positions of the plurality of data values set as the name identification target in the database when the database is subjected to aggregation processing.

6. A computer readable recording medium configured to record a program for instructing a computer to function as a group map generating unit configured to generate a group map file that stores values converted from data values set as a name identification target in a manner such that they are associated with corresponding positions of the plurality of data values set as the name identification target in the database when the database is subjected to aggregation processing.
